(19) United States
(12) Patent Application Publication
(10) Pub. No.: US 2026/0357025 A1
(43) Pub. Date: Nov. 12, 2026

(54) MICROWAVE PROCESSING OF FOAMED PACKING MATERIALS

(71) Applicant: Cruz Foam, Inc., Santa Cruz, CA (US)

(72) Inventors: Marco Rolandi, Santa Cruz, CA (US); William Thomas Lewczyk, Santa Cruz, CA (US); Jack Selberg, Santa Cruz, CA (US); Dylan Brown, Santa Cruz, CA (US)

(73) Assignee: Cruz Foam, Inc., Santa Cruz, CA (US)

(21) Appl. No.: 19/125,184

(22) PCT Filed: Oct. 27, 2023
(86) PCT No.: PCT/US2023/078089

§ 371 Date: Apr. 28, 2025

Related U.S. Application Data
(60) Provisional application No. 63/381,226, filed on Oct. 27, 2022.

(51) Int. Cl. C08J 9/00; B29C 35/08; B29C 44/02; B29C 44/34; B65D 81/03; C08J 9/08; C08J 9/10

(52) U.S. Cl. CPC C08J 9/0047; B29C 35/0805; B29C 44/022; B29C 44/3415; B65D 81/03; C08J 9/0023; C08J 9/0061; C08J 9/08; C08J 9/103; B29C 2035/0855; C08J 2203/02; C08J 2303/00; C08J 2389/00; C08J 2429/04

(57) ABSTRACT

Packaging is extensively used to ship products. Such mailers are used to encompass and protect the object inside the packaging. The protection is often provided by foams or pockets of air. A major issue with such packaging is that the materials of the packaging resist degradation and accumulate in landfills or in the environment. Thus, there is a need for packaging that can undergo degradation. Presented is a new biological foam material that is useable in packaging. The foam material is made of biological polymer materials and undergoes degradation under normal environmental conditions alleviating the accumulation of packaging materials in landfills and the environment.

### CROSS-REFERENCE TO RELATED APPLICATION

This application claims the benefit of U.S. Provisional Application No. 63/381,226, filed on Oct. 27, 2022, which is hereby incorporated by reference in its entirety.

### TECHNICAL FIELD

This disclosure relates generally to foam manufacturing, and in particular but not exclusively, relates to biodegradable foam precursors and foam products.

### BACKGROUND INFORMATION

Plastics are commonly used in packaging materials including crates, boxes, and mailers. Plastics when used as packaging are inherently wasteful by typically being one time use (e.g., to protect a product traversing being shipped from a manufacturer or retailer to a consumer) while also unlikely to be recycled. The lack of recyclability means most waste from packaging materials ends up in an incinerator, a landfill, or otherwise accumulates in the environment. Plastic foams (e.g., expanded polystyrene), in particular, are regularly used as packaging materials and may significantly contribute to plastic pollution due to the inherent ability of polystyrene to resist biodegradation. One avenue to address the ongoing crisis of plastic pollution due to packaging is to replace plastics used in packaging with more environmentally friendly variants that are biodegradable.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect a slurry precursor for a foam is presented and comprises a liquid medium; a blowing agent; a biological polymer; where the slurry precursor turns into a solid foam when exposed to microwave radiation, radiofrequency radiation, or heat.

### BRIEF DESCRIPTION OF THE DRAWINGS

Non-limiting and non-exhaustive embodiments of the disclosure are described with reference to the following figures, wherein like reference numerals refer to like parts throughout the various views unless otherwise specified. The drawings are not necessarily to scale, emphasis instead being placed upon illustrating the principles being described.

FIG. 1 depicts a schematic of the process of implementation of the dry foam mailer product. The dry ingredients and liquid are mixed into a slurry. The slurry is placed into a dispenser and applied to a paper support of the mailer. The slurry is then subjected to microwave, radiofrequency or heat which initiated the foaming process which ultimately leads to the mailer product.

FIG. 2 depicts an example of a printing dispenser loaded with slurry and printing onto a mailer substrate.

FIG. 3 depicts an example of syringe dispensing onto paper.

FIG. 4 depicts slurry being transfer from a mixing vessel to a bag applicator.

FIG. 5 depicts an example of slurry dispensing out of a bag applicator.

FIG. 6 depicts an example of slurry after microwaving process.

FIG. 7 depicts an example of slurry placement in a thin layer between two layers of paper.

FIG. 8 depicts an example of an arbitrary placement of foamed material in a thin layer after the microwaving process.

FIG. 9 depicts an example of foam creating in thin layer after opening up the paper sandwich layer.

FIG. 10 depicts an example of single dot of foamed material.

FIG. 11 depicts an example of the foamed material encased by paper.

FIG. 12 depicts the microwaved slurry inside two layers of papers forming a sandwich.

FIG. 13 depicts slurry foam stress versus strain curves.

### DETAILED DESCRIPTION

Embodiments of foam precursors and foam with biodegradable copolymer and corresponding methods of manufacture are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Existing packaging (e.g., shipping envelopes, boxes, crates) come in two general forms: with and without a cushioning layer. Cushioning is a key element of protective packaging as protection of the goods inside the package is of importance. The use of closed cell extruded polystyrene foam or bubble wrapping, as a cushioning component in packaging is known. Such materials may not be recyclable or compostable. Thus, most end up as landfill waste where much of the packaging can persist as the materials resist degradation in the natural environment. Even if the packaging materials are recyclable, it is established that plastic products are recycled at a much lower rate than paper-based products. More environmentally friendly approaches to making packaging have been attempted based on cellulosic materials and water-based adhesives; however, such packaging materials may not be sufficiently durable to provide suitable properties (e.g., effective thermal insulation, impact protection, and compression resistance).

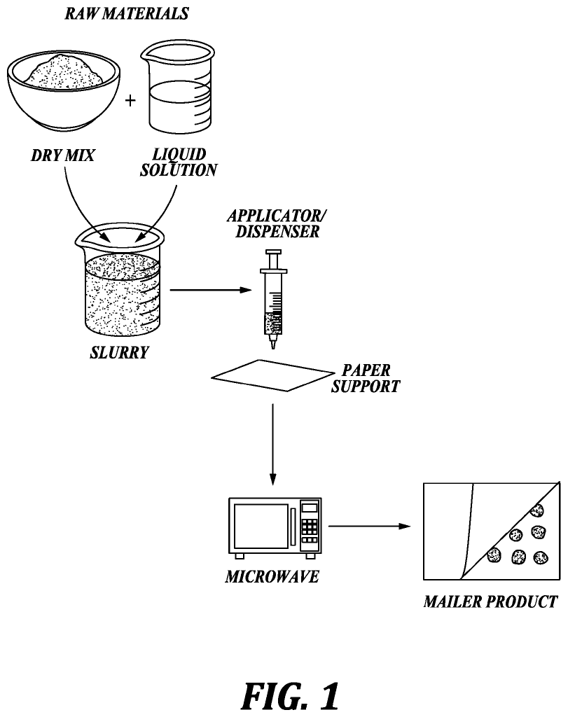

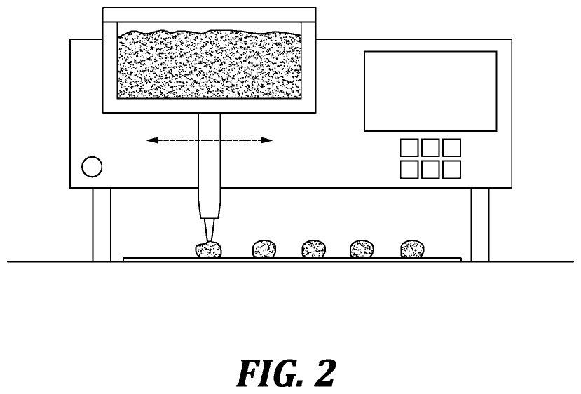

The present disclosure provides biological polymeric foamed compositions, foam padded materials that include such biological polymeric foamed compositions, and packaging articles (e.g., envelopes) that include such foam padded materials. FIG. 1 shows the sequence of events in the preparation of packaging materials. The dry materials such include items as the biological binding agent, secondary agent, blowing agents, and plasticizers and blended with a liquid to yield a slurry. The slurry is added to a dispenser and then dispensed onto paper substrates. In one embodiment the paper substrates are that of packaging designed for mailing. However, one skilled in the art will recognize that the biological polymeric foamed compositions can be utilized in many applications that require protection, sealing and adhesive. FIG. 2 shows one possible approach to application of the biological polymeric foamed compositions to substrates using printer technology. One skilled in the art will recognize there are many possible methods and means to apply biological polymeric foamed compositions to substrates. In the embodiments below examples are given to implement this disclosure. The examples, chemical substances, and methods given cannot be in any way considered limiting.

### Slurry Embodiments

In an aspect a slurry precursor for a foam is presented and comprises a liquid medium; a blowing agent; a biological polymer; where the slurry precursor turns into a solid foam when exposed to microwave radiation, radiofrequency radiation, or heat.

As described herein, a biological polymer is an oligomer, polymer, network polymer, or otherwise macromolecule that is derive from a source found in nature or is synthetic version of an oligomer, polymer, network polymer, or otherwise macromolecule found in nature. A second polymer material is an oligomer, polymer, network polymer, or otherwise macromolecule that is added to the biological polymer to complement and adjust the biological polymer in a beneficial way. A liquid medium is a substance whose melting point is below that of room temperature and has compatibility with the biological polymer or secondary polymer either as a solvent or as a dispersant. A blowing agent is a chemical entity that releases a gas when subjected to a stimulus such as radiation or heat. A crosslinking agent is a chemical entity that links an oligomer, polymer, network polymer, or otherwise macromolecule to another oligomer, polymer, network polymer, or otherwise macromolecule. A foam nucleating agent is a chemical entity that gas nucleates around. Glass transition temperature is the temperature at which an oligomer, polymer, network polymer, or otherwise macromolecule transitions from a glassy material to a rubbery material. Oligomer, polymer, network polymer, or otherwise macromolecule with a glass transition temperature below 25 °C are generally rubbery and oligomer, polymer, network polymer, or otherwise macromolecule with glass transition temperature significantly over room temperature is generally glassy. A plasticizer may be added to oligomer, polymer, network polymer, or otherwise macromolecule to lower the glass transition temperature, often to change a glassy substance to a rubbery substance.

In some embodiments the biological binding material is a carbohydrate, a protein, a polyester, a rubber, a phenolic, or combinations thereof.

In some embodiments the biological polymer is a carbohydrate such as starch, chitosan, hyaluronan, pectin, gum Arabic, locust bean gum, xanthan gum, guar gum, konjac gum, gelatin, carrageenan, amylose, amylopectin, cellulose, inulin, hydroxyethyl cellulose, carboxymethyl cellulose, or combinations thereof.

In some embodiments the biological polymer is a protein is gelatin, myosin, actin, tropomyosin, troponins, or combinations thereof.

In some embodiments the biological polymer is a polyester, and the polyester is polyhydroxyalkanoates, poly(3-hydroxybutyrate), poly(3-hydroxybutyrate-co-3-hydroxyvalerate), polylactic acid, or combinations thereof.

In some embodiments the biological polymer is a rubber, and the rubber is a polymer that includes isoprene.

In some embodiments the biological polymer is a phenolic and the phenolic is suberin, lignin, cutin, cutan, or combinations thereof.

In some embodiments the blowing agent is water, acetone, methanol, chloroform, dichloromethane, pentane, hexane, carbon dioxide, a hydride salt, an isocyanate, a bicarbonate salt, a carbonate salt or an azo compound.

In some embodiments the blowing agent is a hydride salt, and the hydride salt is tantalum hydride, titanium hydride, or combinations thereof.

In some embodiments the blowing agent is an isocyanate, and the isocyanate is methyl isocyanate, ethyl isocyanate, hexamethylene diisocyanate, toluene diisocyanate, isophorone diisocyanate, or combinations thereof.

In some embodiments the blowing agent is a bicarbonate salt, and the bicarbonate salt is ammonium bicarbonate, lithium bicarbonate, sodium bicarbonate, potassium bicarbonate, rubidium bicarbonate, cesium bicarbonate, aqueous magnesium bicarbonate, or combinations thereof.

In some embodiments the blowing agent is a carbonate salt, and the carbonate salt is magnesium carbonate, calcium carbonate, strontium carbonate, barium carbonate, lithium carbonate, sodium carbonate, potassium carbonate, rubidium carbonate, cesium carbonate, ferrous carbonate, nickel carbonates, cobalt carbonate, copper carbonate, zinc carbonate, stannic carbonate, chromium carbonate, vanadium carbonate, or combinations thereof.

In some embodiments the blowing agent is an azo compound and the azo compound is azobenzene, azobisisobutyronitrile, 2,2′-azobis [2-methyl-N-(2-hydroxyethyl) propionamide], 2,2′-azobis(2-methylpropionamidine) dihydrochloride, 2,2′-azobis [2-(2-imidazolin-2-yl) propane]dihydrochloride, 4,4′-azobis(4-cyanovaleric acid), 1,1′-azobis(cyclohexane-1-carbonitrile), azodicarbonamide, 1,1-azobisformamide. p-toluenesulfonylsemicarbazide, 5-phenyltetrazole, or combinations thereof.

In some embodiments the blowing agent is up to 0.1 wt %, up to 0.2 wt %, up to 0.3 wt %, up to 0.4 wt %, up to 0.5 wt %, up to 0.6 wt %, up to 0.7 wt %, up to 0.8 wt %, up to 0.9 wt %, up to 1.0 wt %, up to 1.1 wt %, up to 1.2 wt %, up to 1.3 wt %, up to 1.4 wt %, up to 1.5 wt % of the slurry composition.

In some embodiments the slurry additionally comprises a nucleating agent.

In some embodiments the nucleating agent is 0.5-1.2 wt % of the slurry composition.

In some embodiments the liquid medium is water, acetic acid, citric acid, methanol, ethanol, acetone, methylene chloride, chloroform, carbon dioxide, or combinations thereof.

In some embodiments liquid medium ranges from 10-80 wt %, 15-70 wt %, 20-65 wt %, or 25-60 wt % of the slurry composition.

In some embodiments the liquid medium ranges from 30-50% by weight of the slurry composition.

In some embodiments the liquid medium and blowing agent are the same.

In some embodiments the blowing agent is soluble or insoluble in the liquid medium.

In some embodiments the slurry additionally comprises a plasticizer.

In some embodiments the plasticizer is glycerol, urea, triethyl citrate, tributyl citrate, castor oil, polyhydroalcohols, diethyl succinate, dibutyl succinate, diamyl succinate, dihexyl succinate, dibutyl phthalate, dioctyl phthalate, tri (2-ethylhexyl)phosphate, or combinations thereof.

In some embodiments the slurry additionally comprises a surfactant.

A surfactant is a chemical substance that allows for one medium to be dispersed into another medium where the two mediums would otherwise not be compatible with each other. In the current instance a surfactant allows for gas from the blowing agent to be uniformly distributed in the slurry composition and resulting solid foam. One skilled in the will recognize that there are many substances that can act as a surfactant and the examples set forth are in no way limiting.

In some embodiments the surfactant is sodium dodecyl sulfate, ammonium dodecyl sulfate, cocamide diethanolamine, cocamidopropylamine oxide, cocamidopropyl betaine, cocamidopropyl hydroxysultaine, sodium coceth sulfate, phosphatidylcholine, 4-(5-dodecyl)benzenesulfonate, sodium stearate, sodium palmitate, sodium dodecate, sodium myristate, sodium margarate, dioctyl sodium sulfosuccinate, perfluorooctanesulfonate, octaethylene glycol monododecyl ether, pentaethylene glycol monododecyl ether, cocamide monoethanolamine, cocamide diethanolamine, glycerol monostearate, glycerol monolaurate, sorbitan monolaurate, sorbitan monostearate, sorbitan tristearate, decyl glucoside, lauryl glucoside, octyl glucoside, Tween 20, Tween 40, Tween 60, Tween 80, or combinations thereof.

In some embodiments the slurry additionally comprises a pH modifier.

A pH modifier as described herein is a chemical substance that adjusts the pH (the hydroxide [electron donor] and hydronium concentrations [electron acceptor]) of the slurry composition. One skilled in the will recognize that there are many substances that change the pH of a liquid medium and the examples set forth are in no way limiting.

In some embodiments the slurry pH modifier is lithium hydroxide, sodium hydroxide, potassium hydroxide, rubidium hydroxide, cesium hydroxide, calcium hydroxide, strontium hydroxide, barium hydroxide, or combinations thereof.

In some embodiments the slurry pH is over 7.0.

In some embodiments the slurry pH is between 11-13.

In some embodiments the pH modifier is up to 0.1 wt %, up to 0.2 wt %, up to 0.3 wt %, up to 0.4 wt %, up to 0.5 wt %, up to 0.6 wt %, up to 0.7 wt %, up to 0.8 wt %, up to 0.9 wt %, up to 1.0 wt % of the slurry composition.

In some embodiments the pH modifier is 0.1-0.2 wt % of the slurry composition.

In some embodiments the slurry comprises a secondary polymer.

In some embodiments the secondary polymer material is selected from the group of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (meth)acrylic, styrene (meth)acrylic, (meth)acrylic, styrene butyl rubber, natural rubber, styrenic block copolymer, polyurethane, or combinations thereof.

In some embodiments the biological polymer component of the foamed composition comprises up to 99 wt %, up to 90 wt %, up to 85 wt %, up to 75 wt %, up to 60 wt %, up to 50 wt %, up to 40 wt %, or up to 30 wt % of the slurry composition.

In some embodiments the biological polymer is 45-50 wt % of the slurry composition.

In some embodiments the second polymer binding material component of the foamed composition comprises up to 99 wt %, up to 90 wt %, up to 85 wt %, up to 75 wt %, up to 60 wt %, up to 50 wt %, up to 40 wt %, or up to 30 wt % of the slurry composition.

In some embodiments the second polymer binding material component of the foamed composition comprises 0.3-0.5 wt % of the slurry composition.

In some embodiments the slurry comprises a crosslinking agent.

In some embodiments the crosslinking agent is borax, phosphorous oxychloride, adipate, epichlorohydrin, sodium periodate, citric acid, oxidized sucrose, or combinations thereof.

In some embodiments the crosslinking agent is up to 1 wt %, up to 2 wt %, up to 3 wt %, up to 4 wt %, up to 5 wt %, up to 6 wt %, up to 7 wt %, up to 8 wt %, up to 9 wt %, up to 10 wt % of the slurry composition.

In some embodiments the crosslinking agent is 5-7 wt % of the slurry composition.

In some embodiments the nucleating agent is talc, mica, a carbonate salt, triphenyl phosphine, tributyl phosphine, trimethyl phosphine, dimethyl phenyl phosphine, methyl diphenyl phosphine, tris(2-ethylhexyl)phosphine, tetrabutyl-phosphonium hexafluorophosphate, tetrabutyl-phosphonium-hydrogen sulfate, tetrabutylammonium-phenylphosphonate), tritylpyridinium tetrafluoroborate, 1-butyl-1-methylpyrrolidinium bromide, triphenylsulfonium tetrafluoroborate, sodium octyl sulfonate, phosphonic acids, esters, and salts, phosphinic acid, esters, and salts, phosphonamides, phosphinamides, or tetrabutylammonium-phenylphosphonate.

In some embodiments the nucleating agent carbonate salt is calcium carbonate.

In some embodiments the nucleating agent is up to 0.1 wt %, up to 0.2 wt %, up to 0.3 wt %, up to 0.4 wt %, up to 0.5 wt %, up to 0.6 wt %, up to 0.7 wt %, up to 0.8 wt %, up to 0.9 wt %, up to 1.0 wt % of the slurry composition.

In some embodiments the nucleating agent is 0.5-1.0 wt % of the slurry composition.

In some embodiments the slurry additionally comprises a shear thinning agent.

A shear thinning agent as described herein is a chemical substance that changes the viscosity, rheology, of a substance. One skilled in the art will recognize that many chemical substances can modify the rheology of a substance and the examples set forth are in no way limiting.

In some embodiments the shear thinning agent is gum Arabic, locust bean gum, xanthan gum, guar gum, konjac gum, or combinations thereof.

In some embodiments the shear thinning agent is up to 0.1 wt %, up to 0.2 wt %, up to 0.3 wt %, up to 0.4 wt %, up to 0.5 wt %, up to 0.6 wt %, up to 0.7 wt %, up to 0.8 wt %, up to 0.9 wt %, up to 1.0 wt % of the slurry composition.

In some embodiments the shear thinning agent is 0.5-1.0 wt % of the slurry composition.

In some embodiments the viscosity of the slurry is 500-3000 centipoise.

In some embodiments the viscosity of the slurry is 1500-2200 centipoise.

In some embodiments the slurry exhibits non-Newtonian rheology.

### Method of Making the Foam Embodiments

In another aspect a method of forming a solid foam biomaterial is presented where the slurry is exposed to microwave radiation, radiofrequency radiation, or heat; where the microwave radiation, radiofrequency radiation, or heat induces gas formation; where the gas formation results in a cellular void structure within the slurry, where the slurry crosslinks and solidifies.

In some embodiments the microwave expansion is performed in an Inverter microwave which is used to initiate the foam formation with microwaves at a frequency of 2.45 GHz and an approximate wavelength of 12 cm.

In some embodiments the slurry in dot formation is microwaved between paper supports at 1200 watts for at least 10 seconds but not more than 35 seconds.

In some embodiments the slurry is microwaved at 1200 watts for 20-25 seconds.

In some embodiments the microwave frequency is about 3 GHz to about 30 GHz.

One skilled in the art will recognize that different frequencies and power levels other than 1200 watts can be utilized to practice this disclosure. The embodiments given here are in no way limiting and do not exclude the use of different power levels and frequencies of microwave radiation.

In some embodiments the slurry is exposed to a convection oven with temperatures of up to 500 F.

In some embodiments the slurry is exposed to temperatures of 350-500 F for 10-60 seconds.

In some embodiments the slurry is exposed to temperatures of 450-475 F for 30-40 seconds.

One skilled in the art will recognize that different temperatures and exposure times can be utilized to practice this disclosure. The embodiments given here are in no way limiting and do not exclude the use of different temperatures and exposure times of thermal radiation.

In some embodiments the foamed material includes a biological polymer binding agent and a secondary polymer, where the biological binding agent and the secondary polymer may be water soluble or insoluble.

In some embodiments the method of forming a solid foam material where the foamed biomaterial includes a plasticizer.

In some embodiments the method of forming a solid foam material where the slurry contains a biological polymer.

In some embodiments the method of forming a solid foam material where the biological polymer is starch or chitosan.

In some embodiments the method of forming a solid foam material where the blowing agent is water, sodium bicarbonate, calcium carbonate or an azodicarbonamide.

In some embodiments the method of forming a solid foam material where the biological polymer is chitosan dissolved in a water solution that may or may not contain acetic acid or citric acid.

In some embodiments the method of forming a solid foam material where the blowing agent is sodium bicarbonate or calcium carbonate that forms CO2 when combined with the acid and an additional CO2 when exposed to microwave (MW) radiation, radiofrequency (RF) radiation, or heat.

In some embodiments the method of forming a solid foam material where the blowing agent is an azo compound which forms nitrogen gas when exposed to microwave (MW) radiation, radiofrequency (RF) radiation, or heat.

In some embodiments the method of forming a solid foam material where the azo blowing agent is azodicarbonamide.

In some embodiments the method of forming a solid foam material where the pH is over 7.0.

In some embodiments the method of forming a solid foam material where the pH is 11-13.

### Foam Composition

In another aspect a foamed biomaterial is presented that comprises a biological polymer; where the biological polymer, is a component of a slurry from any of the embodiments disclosed herein; a void cellular structure within the polymer structure; where the biological polymer crosslinks; and where the foamed biomaterial containing the void cellular structure results from an expanding gas from a slurry when exposed to microwave radiation, radiofrequency radiation, or heat.

In some embodiments the foamed biomaterial is presented where the density is about 35 kg/m³ to about 150 kg/m³, 25 kg/m³ to about 125 kg/m³, 20 kg/m³ to about 100 kg/m³, 15 kg/m³ to about 75 kg/m³, or 10 kg/m³ to about 60 kg/m³, compressive strength is about 1 kPa to about 12 kPa at 25% strain, 0.8 kPa to about 8 kPa at 25% strain, 0.6 kPa to about 6 kPa at 25% strain, or 0.4 kPa to about 4 kPa at 25% strain and foam maintains energy absorbance capabilities through five repeated compressions with 5 psi.

In some embodiments the foamed biomaterial is presented where the biological polymer is chitosan or starch.

In some embodiments the foamed biomaterial additionally comprises a second polymer binding material.

In some embodiments the foamed biomaterial is presented where the second polymer binding material is selected from the group of butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (meth)acrylic, styrene (meth)acrylic, (meth)acrylic, styrene butyl rubber, natural rubber, styrenic block copolymer, polyurethane, or combinations thereof.

In some embodiments the foamed biomaterial additionally comprises a nucleating agent.

In some embodiments the foamed biomaterial is presented where the nucleating agent is talc, mica, triphenyl phosphine, tributyl phosphine, trimethyl phosphine, dimethyl phenyl phosphine, methyl diphenyl phosphine, tris(2-ethylhexyl)phosphine, tetrabutyl-phosphonium hexafluorophosphate, tetrabutyl-phosphonium-hydrogen sulfate, tetrabutylammonium-phenylphosphonate), tritylpyridinium tetrafluoroborate, 1-butyl-1-methylpyrrolidinium bromide, triphenylsulfonium tetrafluoroborate, sodium octyl sulfonate, phosphonate, phosphonic acids, esters, and salts, phosphinic acid, esters, and salts, phosphonamides, phosphinamides, or tetrabutylammonium-phenylphosphonate.

In some embodiments the foamed biomaterial is presented where the expanding gas is carbon dioxide or nitrogen.

In some embodiments the foamed biomaterial additionally comprises a plasticizer.

In some embodiments the foamed biomaterial is presented where the plasticizer is glycerol, urea, triethyl citrate, tributyl citrate, castor oil, polyhydroalcohols, diethyl succinate, dibutyl succinate, diamyl succinate, dihexyl succinate, dibutyl phthalate, dioctyl phthalate, tri (2-ethylhexyl)phosphate, or combinations thereof.

In some embodiments the foamed biomaterial is presented where the foamed biomaterial additionally comprises a surfactant.

In some embodiments the foamed biomaterial is presented where the surfactant is sodium dodecyl sulfate, ammonium dodecyl sulfate, cocamide diethanolamine, cocamidopropylamine oxide, cocamidopropyl betaine, cocamidopropyl hydroxysultaine, sodium coceth sulfate, phosphatidylcholine, 4-(5-dodecyl)benzenesulfonate, sodium stearate, sodium palmitate, sodium dodecate, sodium myristate, sodium margarate, dioctyl sodium sulfosuccinate, perfluorooctanesulfonate, octaethylene glycol monododecyl ether, pentaethylene glycol monododecyl ether, cocamide monoethanolamine, cocamide diethanolamine, glycerol monostearate, glycerol monolaurate, sorbitan monolaurate, sorbitan monostearate, sorbitan tristearate, decyl glucoside, lauryl glucoside, octyl glucoside, Tween 20, Tween 40, Tween 60, Tween 80, or combinations thereof.

In some embodiments the foamed biomaterial is presented where the foamed biomaterial additionally comprises byproducts of the blowing agent.

In some embodiments the foamed biomaterial is presented where the byproducts of the blowing agent is sodium oxide, calcium oxide, sodium hydroxide, calcium hydroxide, nitrile, amide, citrate, acetate, or combinations thereof.

In some embodiments the foamed biomaterial is presented where the foamed biomaterial is crosslinked.

### Substrates

In an aspect a coated substrate is presented that comprises a sheet material having a surface having disposed thereon a foamed biomaterial composition which is activated by microwave radiation, radiofrequency radiation, or heat of any of the embodiments disclosed herein.

A substrate is a material in which the slurry that yields the biological foam or the biological foam is deposited upon or otherwise exists upon. One skilled in the art will recognize that many different substrates can be utilized in exercising the described slurries and foam compositions and the examples that follow are in no way limiting.

In some embodiments the coated substrate is sheet material that comprises a recyclable material.

In some embodiments the coated substrate is recyclable material that comprises a repulpable material.

In some embodiments the coated substrate is repulpable material that comprises repulpable paper.

In some embodiments the coated substrate is repulpable paper that comprises a fiberboard, chipboard, corrugated boards corrugated medium, solid bleached board (SBB), solid bleached sulphite board (SBS), solid unbleached board (SLB), white lined chipboard (WLC), kraft paper, kraft board, coated paper, binder board, waxed paper, or mixtures thereof.

In some embodiments the coated substrate is a slurry of any of the embodiments disclosed herein that is sandwiched between two parallel pieces of paper so that the gas bubbles in the slurry can be trapped during the foaming process.

### Padded Product (e.g., Mailer) Including Foam Embodiments.

In an aspect a recyclable and/or compostable biological foam of any of the embodiments disclosed herein incorporated into a padded material is presented that comprises: a sheet material having a first and a second major surface, a second sheet material having a first and a second major surface, wherein the sheet material comprises recyclable material; and a slurry disposed on the first major surface of the sheet material, wherein the slurry is sandwiched between two parallel pieces of sheet material so that the gas bubbles in the slurry can be trapped during the foaming process, the slurry composition comprising: a biological polymeric binding component comprising a biological polymer material, a second polymer material, a blowing agent, a plasticizer, a nucleating agent, a liquid medium, wherein the foamed composition is in the form of an at least partially water-soluble foam and the foaming process is activated by microwave radiation, radiofrequency radiation, or heat.

In some embodiments the foam padded material is presented where the foamed composition is disposed in a discontinuous pattern comprising an array of discrete elements.

As described within this disclosure an element is a geometric shape in which the slurry is applied to a substrate and resulting foam may take. One skilled in the art will recognize that the slurry and the resulting foam can take upon many shapes and sizes and the examples set forth are in no way limiting.

In some embodiments the foam padded material is presented where the elements comprise one or more geometric shapes comprising squares, rectangles, triangles, spirals, lines, circles, and the like.

In some embodiments the foam padded material is presented where each of the elements of the array of discrete elements has a length and a width, with at least one dimension being in a range of 0.05 inch (1.27 mm) to 2.0 inches (50.8 mm), and at least one dimensions being in a range of 0.1 inch (2.5 mm) to 2.5 inches (63.5 mm).

In some embodiments the foam padded material is presented where each of the elements of the array of discrete elements has a height of at least 2 mm, or at least 0.25 mm.

In some embodiments the foam padded material is presented where each of the elements of the array of discrete elements has a height of up to 50 mm.

In some embodiments the foam padded material is presented where the recyclable material comprises a repulpable material.

In some embodiments the foam padded material is presented where the repulpable material comprises repulpable paper.

In some embodiments the foam padded material is presented where the repulpable paper is selected from the group of fiberboard, chipboard, corrugated boards corrugated medium, solid bleached board (SBB), solid bleached sulphite board (SBS), solid unbleached board (SLB), white lined chipboard (WLC), kraft paper, kraft board, coated paper, binder board, waxed paper, or combinations thereof.

In some embodiments the foam padded material is presented where the foamed composition covers at least 10% of the surface area of the sheet material.

In some embodiments the foam padded material is presented where the foamed composition covers up to 90% of the surface area of the sheet material.

In some embodiments the foam padded material is presented where the slurry composition is disposed on the surface in an amount of at least 5, at least 10, at least 15, or at least 20, grams per square meter.

In some embodiments the foam padded material is presented where the slurry composition is disposed on the surface in an amount of up to 120, up to 110, up to 100, up to 90, up to 80, up to 70, up to 60, up to 50, or up to 40, grams per square meter.

In some embodiments the foam padded material is presented where the biological polymer comprises starch, chitosan, hyaluronan, pectin, gum Arabic, locust bean gum, xanthan gum, guar gum, konjac gum, gelatin, carrageenan, amylose, amylopectin, cellulose, inulin, hydroxyethyl cellulose, carboxymethyl cellulose, or combinations thereof.

In some embodiments the foam padded material is presented where the slurry has at least one of the following properties: a flow index of 0.1 g per 10 min to 60 g per 10 min (measured at 25 °C with a load of 2.16 kg); or a melt temperature of 0 °C to 25 °C.

In some embodiments the foam padded material is presented where the second polymer binding material comprises butanediol vinyl alcohol polymer or copolymer, starch, vinyl acetate/ethylene copolymer, polyvinyl acetate, polyvinyl alcohol, dextrin stabilized polyvinyl acetate, vinyl alcohol/vinyl acetate copolymer, vinyl alcohol/vinyl acetate/ethylene copolymer, stabilized polyvinyl acrylate copolymer, vinyl (meth)acrylic, styrene (meth)acrylic, (meth)acrylic, styrene butyl rubber, natural rubber, styrenic block copolymer, polyurethane, or combinations thereof.

In some embodiments the foam padded material is presented where the biological polymer component of the foamed composition comprises up to 99 wt %, up to 90 wt %, up to 85 wt %, up to 75 wt %, up to 60 wt %, up to 50 wt %, up to 40 wt %, or up to 30 wt %, of the foamed composition.

In some embodiments the foam padded material is presented where the second polymer binding material component of the foamed composition comprises up to 99 wt %, up to 90 wt %, up to 85 wt %, up to 75 wt %, up to 60 wt %, up to 50 wt %, up to 40 wt %, or up to 30 wt %, of the foamed composition.

In some embodiments the foam padded material is presented where the blowing agent is blowing agent is water, acetone, methanol, chloroform, dichloromethane, pentane, hexane, carbon dioxide, magnesium carbonate, calcium carbonate, strontium carbonate, barium carbonate, lithium carbonate, sodium carbonate, potassium carbonate, rubidium carbonate, cesium carbonate, ferrous carbonate, nickel carbonates, cobalt carbonate, copper carbonate, zinc carbonate, stannic carbonate, chromium carbonate, vanadium carbonate, azobenzene, azobisisobutyronitrile, 2,2′-azobis [2-methyl-N-(2-hydroxyethyl) propionamide], 2,2′-azobis(2-methylpropionamidine) dihydrochloride, 2,2′-azobis [2-(2-imidazolin-2-yl) propane]dihydrochloride, 4,4′-azobis(4-cyanovaleric acid), 1,1′-azobis(cyclohexane-1-carbonitrile), azodicarbonamide, 1,1-azobisformamide. p-toluenesulfonylsemicarbazide, 5-phenyltetrazole, or combinations thereof.

In some embodiments the foam padded material is presented where the blowing agent component is present in an amount of at least 10 wt %, at least 7.5 wt %, at least 5 wt %, at least 2.5 wt %, at least 1 wt %, at least 0.5 wt %, or at least 0.1 wt %, based on the total weight of the slurry composition.

In some embodiments the foam padded material is presented where the biological polymer binder component is present in an amount of up to 40-60 wt %, based on the total weight of the foamed composition.

In some embodiments the foam padded material is presented further comprising cellular structure combined with the polymeric component.

In some embodiments the foam padded material is presented where at least 50% of the foam dissolves in 130 °F (54 °C) water according to the Water Solubility Test.

In some embodiments the foam padded material is presented where the foamed composition is durable.

In some embodiments the foam padded material is presented where the foamed material composition is microwave radiation, radiofrequency radiation, or heat sealable.

In some embodiments the foam padded material is presented where the foamed padded material is recyclable.

In some embodiments the foam padded material is presented where the foamed padded material is compostable.

In some embodiments the foam padded material is formed from microwaves at a frequency of 2.45 GHz at an approximate wavelength of 12 cm.

In some embodiments the foam padded material is formed from the slurry of any of the embodiments disclosed herein being microwaved between paper supports at 1200 watts for at least 10 seconds but not more than 35 seconds.

In some embodiments the foam padded material is formed from microwaves at 1200 watts for 20-25 seconds.

In some embodiments the foam padded material is formed from microwave frequency that is about 3 GHz to about 30 GHz.

In some embodiments the foam padded material is formed by temperatures of up to 500 F.

In some embodiments the foam padded material is formed at a temperature of about 350 F to about 500 F for 10-60 seconds.

In some embodiments the foam padded material is formed at a temperature of about 450 F to about 475 F for 30-40 seconds.

### Method Embodiments

In an aspect a method of preparing foam padded material is presented with the method providing for a sheet material having a first and a second major surface, a second sheet material having a first and a second major surface, where the sheet material comprises recyclable material; providing a slurry composition comprising a polymeric component comprising a biological polymer, a second polymer binding material; applying the slurry composition to at least a portion of the first major surface of the sheet material to form a coated substrate; and exposing the coated substrate to microwave radiation, radiofrequency radiation, or heat effective to form a foam from the slurry composition, where the slurry is sandwiched between two parallel pieces of sheet material so that the gas bubbles in the slurry can be trapped during the foaming process.

In some embodiments the method of preparing foam padded material is presented where application comprises screen printing the slurry composition.

In some embodiments the method of preparing foam padded material is presented where application comprises ink jet printing the slurry composition.

In some embodiments the method of preparing foam padded material is presented where application comprises spraying the slurry composition.

In some embodiments the method of preparing foam padded material is presented where application comprises electrodeposition of the slurry composition.

In some embodiments the method of preparing foam padded material is presented where application comprises random element printing the slurry composition.

In some embodiments the method of preparing foam padded material is presented where application comprises exposing the coated substrate to conditions effective to form a foam from the slurry composition comprises microwave radiation, radiofrequency radiation or heat.

### EXAMPLES

The following illustrative examples may aid in understanding the disclosure. However, the disclosure is not necessarily limited to these examples. Embodiments and concepts that are not specifically exemplified may have been disclosed. Unless otherwise noted, all parts, percentages, ratios, etc. in the examples and the rest of the specification are by weight, and all materials used in the examples were obtained, or are available, from general suppliers.

TABLE 1
Material Ranges weight percent in microwave foams produced.

| | % of Formula | Preferable % of |
|---|---|---|
| Material | (w/w) | Formula (w/w) |
| Starch | 40-60 | 45-50 |
| Borax | 1-10 | 5-7 |
| PVA | 0.1-1 | 0.3-0.5 |
| Blowing Agents (sodium | 0.1-2 | 0.5-1.2 |
| bicarbonate preferred) | | |
| Plasticizers (glycerol preferred) | 5-25 | 15-18 |
| Water | 30-60 | 35-45 |
| Sodium Hydroxide | 0-0.4 | 0.1-0.2 |
| Shear Thinning Agents (Xanthan | 0-2 | 0.5-1 |
| gum preferred) | | |
| Talc | 0-2 | 0.5-1 |

The formulation and/or composition of the slurry has the following components with their functionality within the formulation. One skilled in the art that many materials can be substituted for the examples being presented in the following and in not in any way can the following be considered limitations to the implementation of this disclosure.

### 1. Starch

a. Pea starch, High-amylose Cornstarch, Pregelatinized starch
i. Starch provides the main polymer structure in the foam that is enhanced through the addition of the materials below.

### 2. Borax

a. Borax is used as a minor additive to crosslink the starch polymer matrix, increasing strength and durability of the foamed material.

### 3. Polyvinyl Alcohol

a. Can be used to increase film-forming properties of the foam, adhesion between the foam and paper, strength and durability of the foamed polymer matrix, as well as hydrophobicity.

### 4. Blowing Agents

a. sodium bicarbonate, calcium carbonate, azodicarbonamide
i. These blowing agents form carbon dioxide gas or nitrogen gas bubbles in the slurry before processing and in the foam after processing that help decrease the density of the foamed product.

### 5. Plasticizers

a. Glycerol, Urea
i. These increase the flexibility and resiliency of foamed product, but also
increase the density of the foam.
ii. Reduces the energy necessary to mix & pump the slurry precursor.

### 8. Sodium Hydroxide

a. Sodium hydroxide is used to increase the pH of the water above 7 pH and preferably between 11-13 pH to allow the starch to gelatinize at lower temperatures.
b. Many formulas without NaOH did not have good expansion in the microwave.
c. the addition of sodium hydroxide (or other base) to adjust the pH to promote starch gelatinization.

### 6. Water

a. The total amount of water in the slurry precursor ranges from 30-50%
b. Water serves as a vehicle, blowing agent, plasticizer, and stabilizer.

### 7. Paper

a. Uncoated kraft paper, wax-coated paper
i. This serves as the base material for the slurry to be applied to
ii. Slurry is sandwiched between two parallel pieces of paper so that the gas bubbles in the slurry can be trapped during the foaming process.

### 8. Shear-Thinning Agents

a. Guar gum, xanthan gum
i. The gums formed with these additives exhibit a pseudoplastic behavior: as shear force increases the viscosity of the gum decreases. Shear-thinning agents which counteract the shear-thickening effect of the starch in the slurry. Essentially, these agents make the material less viscous as a shear force is applied to them allowing the slurry to flow easier. A small amount of this material, 0-2%, is sufficient to counteract the shear-thickening effect of starch.
ii. These agents can be added to aid in pumping/processing of slurry precursor.

### 9. Talc or Other Nucleator

a. Talc is used to nucleate the foam. Different loading levels of talc are needed depending on the foam composition and moisture content.

TABLE 2
Formulation Examples of Slurry Compositions
to Yield Solid Foam Materials.

| | |
|---|---|
| Material | % of Formula (w/w) |

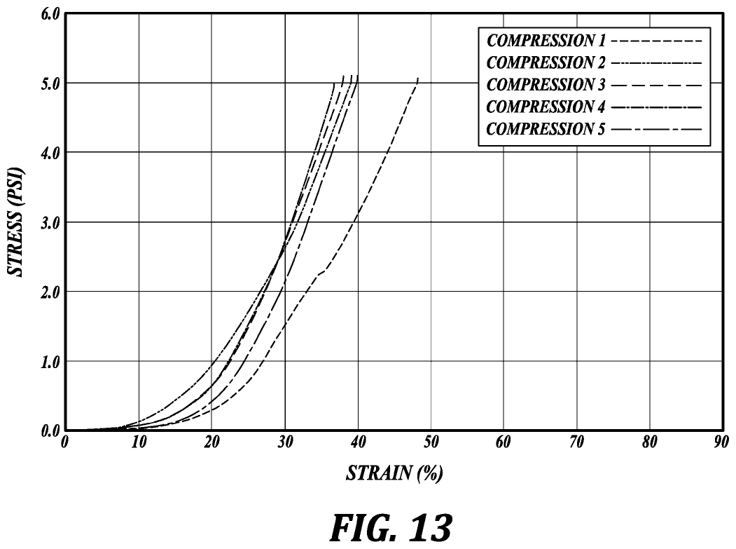

Formulation for FIG. 13 Data

| | |
|---|---|
| Starch | 40.20% |
| Borax | 6.00% |
| PVA | 0.35% |
| Sodium Bicarbonate | 1.61% |
| Glycerol | 16.06% |
| Water | 35.64% |
| Sodium Hydroxide | 0.14% |

Low density (35 kg/m³)

| | |
|---|---|
| Starch | 44.44% |
| Borax | 6.67% |
| PVA | 0.00% |
| Sodium Bicarbonate | 0.00% |
| Glycerol | 8.89% |
| Water | 39.86% |
| Sodium Hydroxide | 0.14% |

Table 2 gives illustrative examples of slurry compositions that yield biological solid foam materials when exposed to energy sources such as heat or microwave radiation. On skilled in the art will recognize that significant deviations from the examples given in Table 2 will also successfully result in sold foam material. The formulations given should in no way be considered limiting. The starch or biological polymer can be anywhere from 30 wt % to 50 wt % of the slurry composition and 41 wt % to 45 wt % of the slurry composition being used in general practice. The crosslinking agent can be anywhere 1 wt % to 15 wt % of the slurry composition When borax is used as the crosslinking agent, 6 wt % of the slurry composition has preferable physical properties whereas 3 wt % allows for better pumpability. The secondary polymer can be anywhere from 0 wt % to 2 wt % of the slurry composition. When poly(vinyl alcohol) is used as the secondary polymer 0.4% yields suitable foam materials. Blowing agents can be used form 5 wt % to 30 wt % of the slurry composition with the preferable being 10 wt % to 15 wt % of the slurry composition. pH modifiers can be used from 0 wt % to 2 wt % of the slurry composition with the preferred being 0.4 wt % of the slurry composition. Water is used as the vehicle, solvent, or dispersing medium and can be used at 20 wt % to 60 wt % of the slurry composition with typical being 35 wt % to 40 wt % of the slurry composition. Shear thinning agents can be anywhere from 0 wt % to 2 wt % of the slurry composition with 0.3 wt % to 0.5 wt % being generally used.

When mixed with water as the vehicle the slurry had a viscosity of 500-3000 centipoise with the viscosity ideally being 1500-2200 centipoise. The slurry exhibited dilatant non-Newtonian rheological properties which are mitigated through the addition of shear thinning agents.

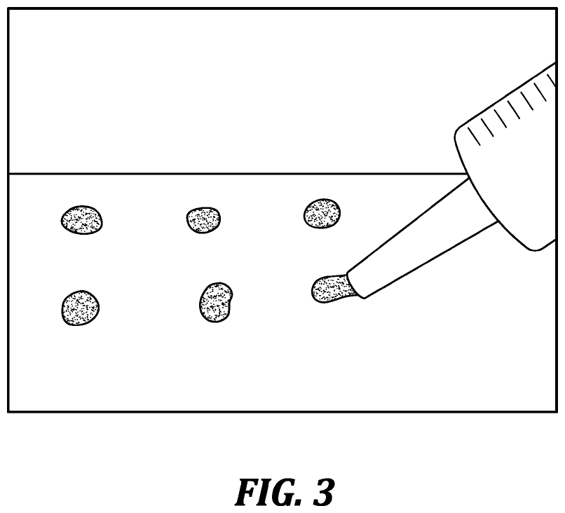

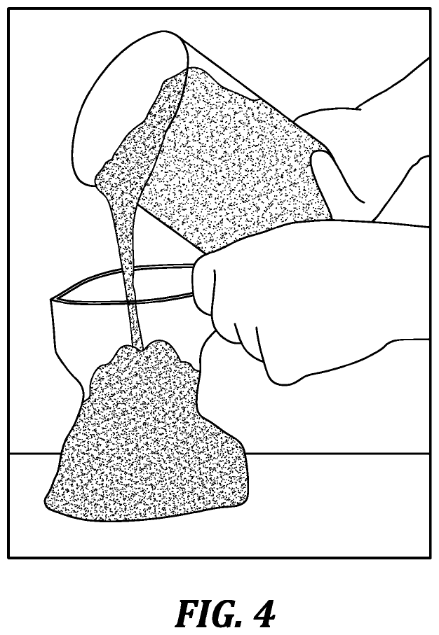

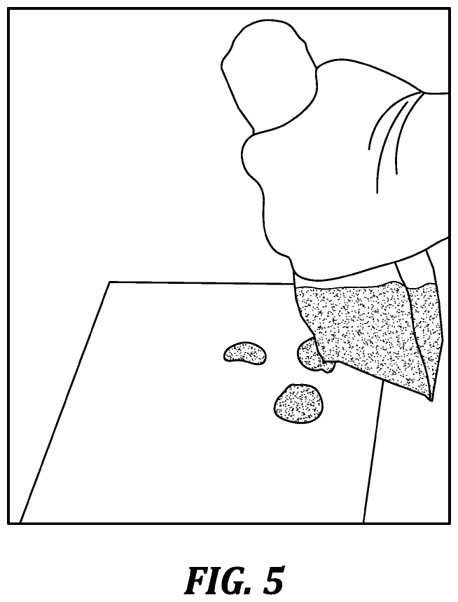

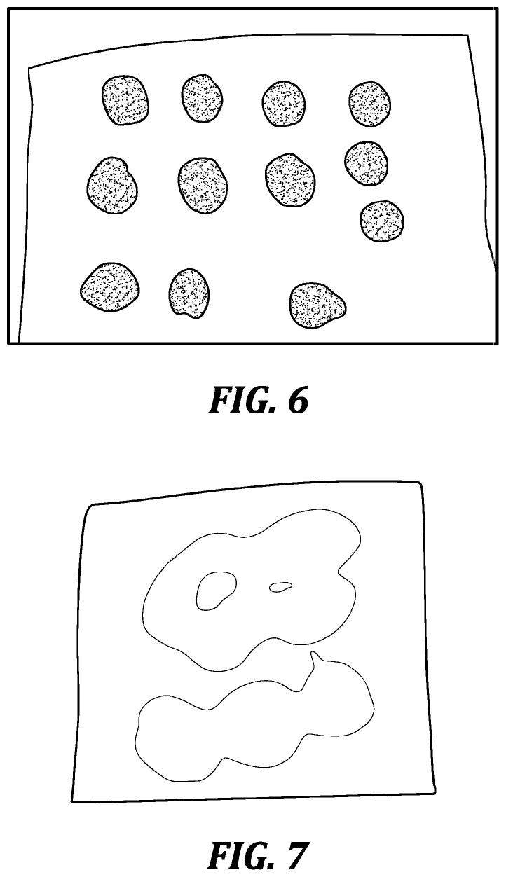

The slurry when mixed and completed can be dispensed by a variety of methods. The slurry in larger scales can be dispensed out of automated liquid dispensing machines that can apply several PSI or more as illustrated in FIG. 2. In smaller scale laboratory settings, the slurry was dispensed out of a 5 mL-50 mL plastic syringe onto wax paper as shown in FIG. 3 with or without a 50-micron mesh filter and 1 mm nozzle. FIGS. 4 and 5 show dispensing the slurry from a confectioner's bag for larger volume experimental testing onto wax paper. When applied by syringe or bag during lower volume testing, the slurry is applied typically as a dot onto paper as shown in FIG. 6. It is possible to dispense the slurry in a form factor other than a dot. It can be spread thin or applied with a roller as shown in FIG. 7.

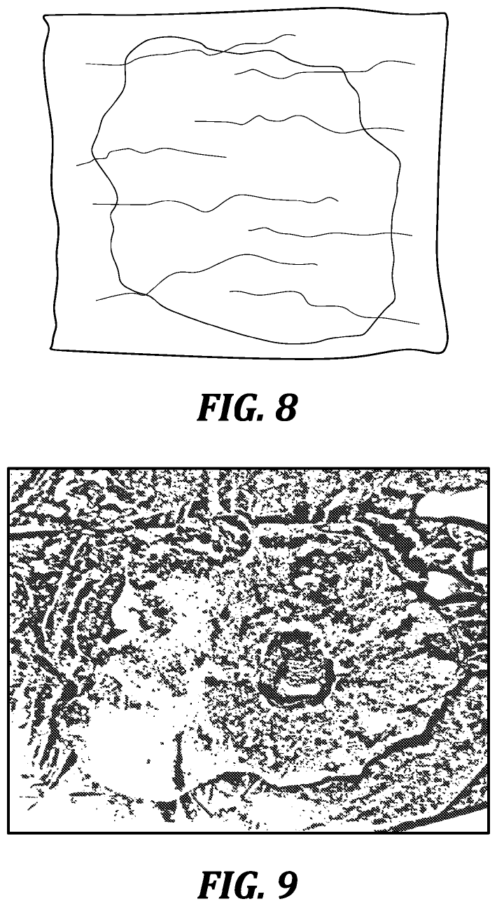

When the slurry is dispensed onto it can be exposed to microwaves to initiate the crosslinking and foaming reactions to yield the foam material on a single sheet of paper as shown in FIGS. 4-6. Alternatively, the slurry can be sandwiched between two sheets of waxed paper as shown in FIG. 8 and exposed to microwave radiation to yield the foam product shown in FIG. 9.

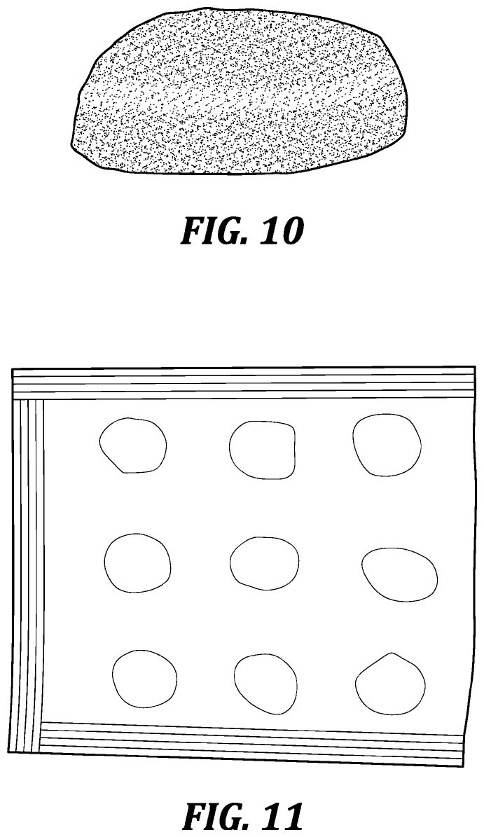

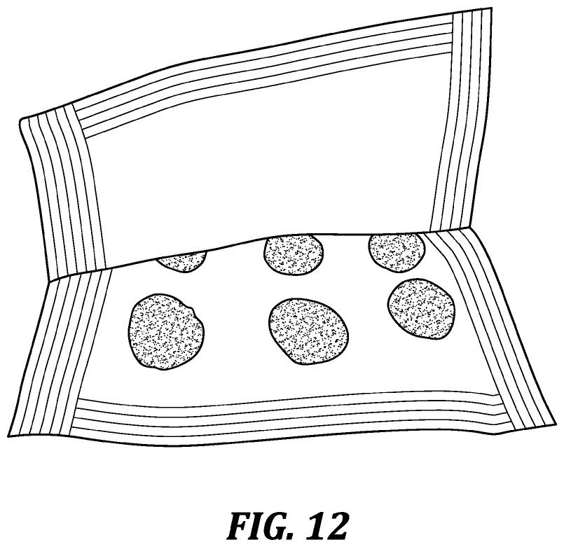

FIG. 10 shows a singular free standing foam dot whereas FIG. 11 shows slurry applied as dots between two sheets of wax paper. The dots sandwiched between two sheets of waxed paper are exposed to microwave radiation. FIG. 12 shows the foamed dots after the slurry was exposed to microwave radiation and the top wax paper layer peeled off.

FIG. 13 shows the stress strain curves for the biological foamed packaging materials presented in this disclosure. The foams give a compressive strength of 1 kPa-12 kPa at 25% strain. The density of the biological foamed materials was 35 kg/m³-150 kg/m³ with the density of the foam for FIG. 13 being 60 kg/m³. Compression curves show the foam maintains energy absorbance capabilities through five repeated compressions with 5 psi.

Reference throughout this specification to “one embodiment”, “an embodiment”, “one example” or “an example” means that a particular feature, structure, or characteristic described in connection with the embodiment is included in at least one embodiment of the present disclosure. Thus, the appearances of the phrases “in one embodiment”, “in an embodiment”, “in one example” or “in an example” in various places throughout this specification are not necessarily all referring to the same embodiment. Furthermore, the particular features, structures, or characteristics may be combined in any suitable manner in one or more embodiments.

The above description of illustrated embodiments of the disclosure, including what is described in the Abstract, is not intended to be exhaustive or to limit the disclosure to the precise forms disclosed. While specific embodiments of the disclosure are described herein for illustrative purposes, various modifications are possible within the scope of the disclosure, as those skilled in the relevant art will recognize.

These modifications can be made to the disclosure in light of the above detailed description. The terms used in the following claims should not be construed to limit the disclosure to the specific embodiments disclosed in the specification. Rather, the scope of the disclosure is to be determined entirely by the following claims, which are to be construed in accordance with established doctrines of claim interpretation.

1. A slurry precursor for a foam comprising:
a liquid medium;
a blowing agent;
a biodegradable polymer;
wherein the slurry precursor turns into a solid foam when exposed to microwave radiation, radiofrequency radiation, or heat.

2. The slurry precursor of claim 1, wherein the biodegradable polymer is a carbohydrate, a protein, a polyester, a rubber, a phenolic, or combinations thereof.

3.-7. (canceled)

4. The slurry precursor of claim 1, wherein the blowing agent is water, acetone, methanol, chloroform, dichloromethane, pentane, hexane, carbon dioxide, a hydride salt, an isocyanate, a bicarbonate salt, a carbonate salt or an azo compound.

5.-14. (canceled)

6. The slurry precursor of claim 1, wherein the liquid medium is water, acetic acid, citric acid, methanol, ethanol, acetone, methylene chloride, chloroform, carbon dioxide, or combinations thereof.

7.-17. (canceled)

8. The slurry precursor of claim 1, wherein the liquid medium and blowing agent are the same.

9. (canceled)

10. The slurry precursor of claim 1, wherein the slurry additionally comprises a plasticizer.

11. (canceled)

12. The slurry precursor of claim 1, wherein the slurry additionally comprises a surfactant.

13. (canceled)

14. The slurry precursor of claim 1, wherein the slurry additionally comprises a pH modifier.

15.-29. (canceled)

16. The slurry precursor of claim 1, wherein the slurry additionally comprises a secondary biodegradable polymer.

17.-35. (canceled)

18. The slurry precursor of claim 1, wherein the slurry additionally comprises a crosslinking agent.

19. The slurry precursor of claim 36, wherein the crosslinking agent is borax, phosphorous oxychloride, adipate, epichlorohydrin, sodium periodate, citric acid, oxidized sucrose, or combinations thereof.

20. (canceled)

21. (canceled)

22. The slurry precursor of claim 1, wherein the slurry additionally comprises a nucleating agent.

23. (canceled)

24. The slurry precursor of claim 40, wherein the nucleating agent carbonate salt is calcium carbonate.

25.-44. (canceled)

26. The slurry precursor of claim 1, wherein the slurry additionally comprises a shear thinning agent.

27.-50. (canceled)

28. The slurry precursor of claim 1, wherein the slurry exhibits non-Newtonian rheology.

29. The slurry precursor of claim 1, wherein the slurry is exposed to microwaves at a frequency of 2.45 GHz and a wavelength of 12 cm.

30. The slurry precursor of claim 1, wherein the slurry is microwaved between paper supports at 1200 watts for at least 10 seconds but not more than 35 seconds.

31.-58. (canceled)

32. A method of forming a biodegradable solid foam from a slurry precursor of claim 1, the method comprising exposing the slurry precursor to microwave radiation, radiofrequency radiation, or heat;
wherein the microwave radiation, radiofrequency radiation, or heat induces gas formation; wherein the gas formation results in a cellular void structure within the slurry precursor; and wherein the slurry precursor crosslinks and solidifies to form the biodegradable solid foam.

33.-79. (canceled)

34. A biodegradable solid foam formed according to the method of claim 59, the biodegradable sold foam comprising:
a void cellular structure within the biological polymer structure.

81.-141. (canceled)
